(19) United States
(12) Patent Application Publication
(10) Pub. No.: US 2006/0236012 A1
(43) Pub. Date: Oct. 19, 2006

(54) Memory controller, image processing controller, and electronic instrument

(75) Inventor: Tadashi Hayashi, Tokyo (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/397,600

(22) Filed: Apr. 5, 2006

(30) Foreign Application Priority Data
Apr. 15, 2005 (JP) 2005-118728

(51) Int. Cl. G06F 13/14

(52) U.S. Cl. 710/241

(57) ABSTRACT

A memory controller for allowing first to Nth (N is an integer of two or more) functional modules to access a memory includes first to Mth (1<M≦N, M is an integer) data transfer control sections each of which issues a data transfer request for the memory corresponding to an access request, a crossbar switch section which supplies an access request from one of the functional modules to one of the first to Mth data transfer control sections, an arbiter which arbitrates between the data transfer requests from the first to Mth data transfer control sections, and a memory interface which accesses the memory based on the data transfer request permitted as a result of arbitration. The data transfer control section generates an access address of the memory and controls access to the memory using the access address.

Japanese Patent Application No. 2005-118728 filed on Apr. 15, 2005, is hereby incorporated by reference in its entirety.

### BACKGROUND OF THE INVENTION

The present invention relates to a memory controller, an image processing controller, and an electronic instrument.

An image processing controller has been known which reduces the processing load imposed on a host which controls a display system by processing an image displayed on a screen of a display device such as a liquid crystal display (hereinafter abbreviated as “LCD”) panel or a CRT instead of the host. The image processing controller performs an image processing using a display memory (memory in a broad sense).

As disclosed in JP-A-8-115069, the function of the display memory may be realized by a synchronous dynamic random access memory (hereinafter abbreviated as “SDRAM”). When the SDRAM is accessed by two or more functional modules (processing module or processing section), an SDRAM controller controls access to the SDRAM by exchanging an address, data, and control signal with each functional module.

In JP-A-8-115069, pattern name data is read from the SDRAM based on a pattern name address generated by pattern name address generation means. A character data address is generated by character data address generation means based on the pattern name data, and the character data is read from the SDRAM based on the generated address.

However, the SDRAM controller cannot access the SDRAM until the functional module including the pattern name address generation means and the character data address generation means outputs the address. Therefore, when the functional module generates the address and requests access to the SDRAM, a period occurs in which the functional module cannot transition to the next operation during the read access operation or the write access operation, whereby the throughput is decreased.

FIGS. 17 and 18 are diagrams illustrative of an example of a period in which the functional module cannot transition to the next operation. FIG. 17 shows a period T1 in which the functional module cannot transition to the next operation during the write access operation. FIG. 18 shows a period T2 in which the functional module cannot transition to the next operation during the read access operation.

During the write access operation, the functional module sets a write request WRReq to active and outputs a write address. In general, the functional module must continuously output the write address until the functional module receives a write acknowledgment WRAck output from the SDRAM controller in response to the write request WRReq. Therefore, the functional module cannot issue the next access request for the SDRAM in the period T1 shown in FIG. 17.

During the read access operation, the functional module sets a read request RDReq to active and outputs a read address. In this case, the functional module must continuously output the read address until the functional module receives a read acknowledgment RDAck output from the SDRAM controller in response to the read request RDReq. After the read acknowledgment RDAck has been set to active, read data is output after the delay time T2 has elapsed. Therefore, the functional module cannot issue the next access request for the SDRAM in the period T2 shown in FIG. 18.

Moreover, since the functional modules must know the state of the access area taking into consideration the case where the access requests for the SDRAM are issued from two or more functional modules which decrease the throughput, the number of combinations of signals exchanged between the functional modules is increased. In particular, more complex signal combinations are required when a functional module is added.

### SUMMARY

A first aspect of the invention relates to a memory controller for allowing first to Nth (N is an integer of two or more) functional modules to access a memory, the memory controller comprising:

first to Mth (1<M≦N, M is an integer) data transfer control sections each of which issues a data transfer request for the memory corresponding to an access request supplied to the data transfer control section;

a crossbar switch section which supplies an access request from one of the first to Nth functional modules to one of the first to Mth data transfer control sections;

an arbiter which arbitrates between the data transfer requests from the first to Mth data transfer control sections; and

a memory interface which accesses the memory based on the data transfer request from one of the first to Mth data transfer control sections permitted as a result of arbitration by the arbiter;

each of the data transfer control sections generating an access address of the memory based on the access request supplied to the data transfer control section, and controlling reading of data from the memory or writing of data into the memory using the access address when the data transfer request for the memory has been permitted as a result of arbitration by the arbiter.

A second aspect of the invention relates to an image processing controller comprising:

first to Nth functional modules each of which issues an access request for a memory;

the above memory controller; and

a memory to which access is controlled by the memory controller.

A third aspect of the invention relates to an image processing controller comprising:

an image data input interface for inputting image data;

the above memory controller;

a display memory to which access is controlled by the memory controller;

a rotation processing section which rotates image data stored in the display memory, the rotation processing section reading the image data from the display memory by issuing a read request to the memory controller, and writing image data obtained by rotating the image data into the display memory by issuing a write request to the memory controller; and

an image data output interface for outputting the image data read from the display memory.

A fourth aspect of the invention relates to an electronic instrument comprising:

a display device;

the above image processing controller; and

a display driver which drives the display device based on image data supplied from the image processing controller.

### BRIEF DESCRIPTION OF THE SEVERAL VIEWS OF THE DRAWING

FIG. 1 is a block diagram showing an outline of a configuration of an image processing controller according to one embodiment of the invention.

FIG. 2 is a block diagram of an outline of a configuration of a memory controller shown in FIG. 1.

FIG. 3 is a diagram illustrative of synchronization signals according to one embodiment of the invention.

FIG. 4 is a diagram showing an example of an operation timing when a functional module issues a write request to a DMA controller in one embodiment of the invention.

FIG. 5 is a diagram showing an example of an operation timing when a functional module issues a read request to a DMA controller in one embodiment of the invention.

FIG. 6 is a block diagram of a configuration example of a DMA controller shown in FIG. 2.

FIG. 7 is a diagram illustrative of a storage area of a display memory.

FIG. 8 is a diagram illustrative of access from a DMA controller by a double buffering method.

FIG. 9 is a diagram illustrative of a write FIFO section and a write synchronization queue section.

FIG. 10 is a block diagram of a configuration example of a write address generation section shown in FIG. 6.

FIG. 11 is a block diagram of a configuration example of a read address generation section shown in FIG. 6.

FIG. 12 is a diagram showing a timing example of signals exchanged between a DMA controller and an arbiter according to one embodiment of the invention.

FIG. 13 is a diagram showing another timing example of signals exchanged between the DMA controller and the arbiter according to one embodiment of the invention.

FIG. 14 is a block diagram of a configuration example of a display controller to which an image processing controller according to one embodiment of the invention is applied.

FIG. 15 is a diagram schematically showing an operation example of the display controller shown in FIG. 14.

FIG. 16 is a block diagram of a configuration example of an electronic instrument according to one embodiment of the invention.

FIG. 17 is a diagram illustrative of an example of a period in which a functional module cannot transition to the next operation.

FIG. 18 is a diagram illustrative of another example of a period in which a functional module cannot transition to the next operation.

### DETAILED DESCRIPTION OF THE EMBODIMENT

The invention may provide a memory controller which improves the throughput of access requested by each functional module irrespective of the number of functional modules while using a general-purpose memory interface, an image processing controller, and an electronic instrument.

One embodiment of the invention relates to a memory controller for allowing first to Nth (N is an integer of two or more) functional modules to access a memory, the memory controller comprising:

first to Mth (1<M≦N, M is an integer) data transfer control sections each of which issues a data transfer request for the memory corresponding to an access request supplied to the data transfer control section;

a crossbar switch section which supplies an access request from one of the first to Nth functional modules to one of the first to Mth data transfer control sections;

an arbiter which arbitrates between the data transfer requests from the first to Mth data transfer control sections; and

a memory interface which accesses the memory based on the data transfer request from one of the first to Mth data transfer control sections permitted as a result of arbitration by the arbiter;

each of the data transfer control sections generating an access address of the memory based on the access request supplied to the data transfer control section, and controlling reading of data from the memory or writing of data into the memory using the access address when the data transfer request for the memory has been permitted as a result of arbitration by the arbiter.

According to this embodiment, the interface processing can be performed between each of the first to Nth functional modules and the memory. This makes it possible to use a general-purpose memory interface as the interface of the memory irrespective of the interface of each functional module, and allows the memory to be accessed from the functional modules through such a general-purpose memory interface.

According to this embodiment, since the access address is generated by the memory controller instead of the functional module, a problem can be prevented in which the functional module cannot transition to the next operation immediately after outputting the access address. This reduces unnecessary operating time of each functional module during the access operation for the memory, whereby the throughput of the processing can be improved.

According to this embodiment, the memory controller includes the data transfer control sections, and the access request from the functional module can be supplied to one of the data transfer control sections by the crossbar switch section. Therefore, signals necessary for arbitration when the data transfer control sections have issued access requests for the memory at the same time can be exchanged inside the memory controller. This makes it unnecessary to additionally provide a signal line for a signal exchanged between the functional modules when adding a functional module, and facilitates addition of a functional module, whereby a memory controller with high extensibility can be provided.

In the memory controller according to this embodiment, when accessing data using a plurality of areas set in a storage area of the memory, each of the data transfer control sections may include a write address generation section which generates a write address for writing data into the memory as the access address, and a read address generation section which generates a read address for reading data from the memory as the access address; the read address generation section may generate the read address for reading data from an area of the memory differing from an area designated by write area information of the memory; and the write area information may be information which designates an area of the memory into which the data is written based on the write address.

According to this embodiment, each data transfer control section includes the write address generation section and the read address generation section, and each address generation section independently receives the access request from the functional module. On the other hand, the read address generation section generates the read address by referring to the write area information accessed by the write address generation section. Therefore, it is unnecessary for the functional module to distinguish the area of the memory when accessing the memory by a double buffering method or a triple buffering method, whereby the functional module need not know the buffering method.

In the memory controller according to this embodiment, the memory may function as a display memory which stores image data; each of the data transfer control sections may include: a read address generation section which generates a read address for reading the image data from the memory as the access address; a read data queue in which the image data read from the memory is queued; and a read synchronization management section which counts a number of pixels of the image data read from the memory and generates a synchronization signal specifying a horizontal display period and a vertical display period of an image expressed by the image data; and the read address generation section may generate the read address which is updated based on the synchronization signal generated by the read synchronization management section.

According to this embodiment, since the data transfer control section queues the data and the like, the access request from each functional module and arbitration between the access requests for the memory occur at different timings. As a result, the blanking period of the image for which the memory is accessed differs in time from the blanking period of the image displayed. Therefore, according to the invention, data transfer to and from the memory is also performed substantially in the blanking period of the image displayed, whereby the throughput of data transfer is improved.

In the memory controller according to this embodiment, the memory may function as a display memory which stores image data; each of the data transfer control sections may include: a write address generation section which generates a write address for writing the image data into the memory as the access address; a write data queue in which the image data written into the memory is queued; and a write synchronization queue in which a synchronization signal specifying a horizontal display period and a vertical display period of an image expressed by the image data written into the memory is queued; and the write address generation section may generate the write address which is loaded at a start timing of the vertical display period and updated corresponding to a queuing state of the write data queue based on the synchronization signal output from the write synchronization queue, and may generate the write address which is updated to an address for writing image data in the next horizontal display period at an end timing of the horizontal display period based on the synchronization signal output from the write synchronization queue.

In the memory controller according to this embodiment, when accessing data using a plurality of areas set in a storage area of the memory, each of the data transfer control sections may include: a read address generation section which generates a read address for reading the image data from the memory as the access address; a read data queue in which the image data read from the memory is queued; and a read synchronization management section which counts a number of pixels of the image data read from the memory and generates a synchronization signal specifying a horizontal display period and a vertical display period of an image expressed by the image data; the read address generation section may generate the read address for reading the image data from an area of the memory differing from an area designated by write area information of the memory, the read address being updated based on the synchronization signal generated by the read synchronization management section; and the write area information may be information which designates an area of the memory into which the data is written based on the write address.

In the memory controller according to this embodiment, one of one-bit start information, and one-bit end information respectively indicating a start timing and an end timing of at least one of the horizontal display period and the vertical display period of the image may be queued in the write synchronization queue as the synchronization signal.

In the memory controller according to this embodiment, the image data in an amount corresponding to a given number of blocks may be queued in the write data queue, each of the blocks containing data in an amount corresponding to a width of a data bus of the memory; and the synchronization signal may be queued in the write synchronization queue in block units.

Another embodiment of the invention relates to an image processing controller comprising:

first to Nth functional modules each of which issues an access request for a memory;

the above memory controller; and

a memory to which access is controlled by the memory controller.

Another embodiment of the invention relates to an image processing controller comprising:

an image data input interface for inputting image data;

the above memory controller;

a display memory to which access is controlled by the memory controller;

a rotation processing section which rotates image data stored in the display memory, the rotation processing section reading the image data from the display memory by issuing a read request to the memory controller, and writing image data obtained by rotating the image data into the display memory by issuing a write request to the memory controller; and

an image data output interface for outputting the image data read from the display memory.

In the image processing controller according to this embodiment, a storage area of the display memory may include a triple buffer area and a double buffer area; the triple buffer area may be accessed by the image data input interface and the rotation processing section; and the double buffer area may be accessed by the rotation processing section and the image data output interface.

According to any of these embodiments, an image processing controller can be provided which includes a memory controller which improves the throughput of access requested by each functional module irrespective of the number of functional modules while using a general-purpose memory interface.

A further embodiment of the invention relates to an electronic instrument comprising:

a display device;

the above image processing controller; and

a display driver which drives the display device based on image data supplied from the image processing controller.

According to this embodiment, an electronic instrument can be provided which includes a memory controller which improves the throughput of access requested by each functional module irrespective of the number of functional modules while using a general-purpose memory interface.

The embodiments of the invention are described below in detail with reference to the drawings. Note that the embodiments described below do not in any way limit the scope of the invention laid out in the claims. Note that all elements of the embodiments described below should not necessarily be taken as essential requirements for the invention.

1. Image Processing Controller

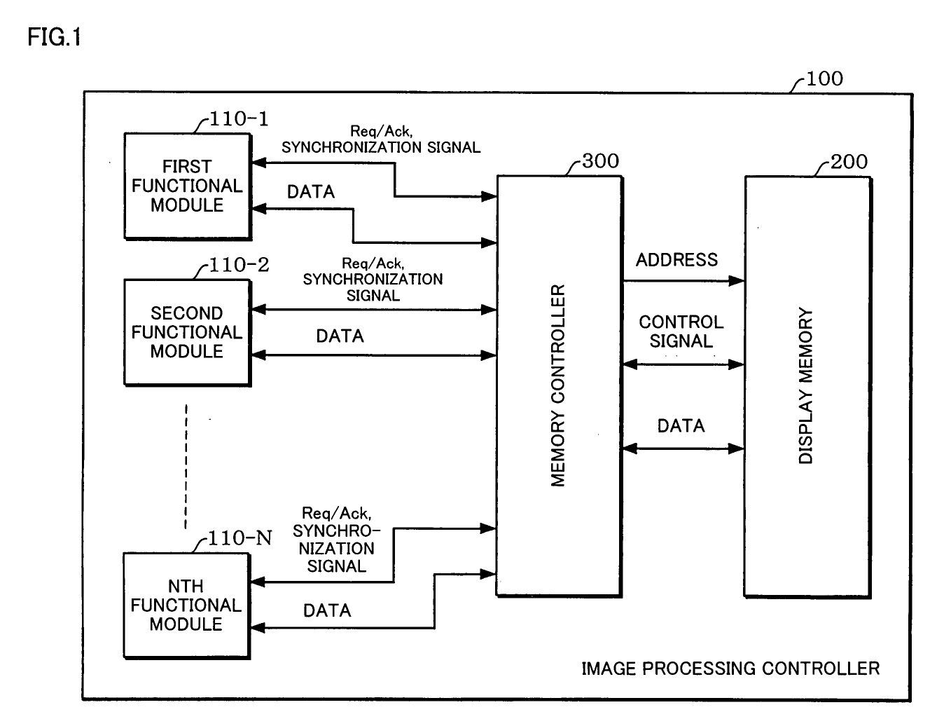

FIG. 1 is a block diagram showing an outline of a configuration of an image processing controller according to one embodiment of the invention.

An image processing controller 100 according to this embodiment includes a display memory 200 which stores image data of a still image or a motion picture, and processes image data (image processing) using the display memory 200. In more detail, the image processing controller 100 includes first to Nth (N is an integer of two or more) functional modules 110-1 to 110-N. One of the first to Nth functional modules 110-1 to 110-N processes image data while accessing the display memory 200. As examples of the functional module, a rotation processing section which rotates an image, an image data compression/decompression section which compresses and decompresses image data, a resizer which scales down and scales up the image size, and the like can be given. An interface circuit which performs interface processing between the image processing controller 100 and an external device may also be used as the functional module.

The image processing controller 100 includes a memory controller 300 which controls access (write control and read control) to the display memory 200 from the first to Nth functional modules 110-1 to 110-N. The memory controller 300 absorbs the difference between the interface specification (signal type, signal timing, signal electrical properties, and the like) of the display memory 200 and the interface specification of each of the first to Nth functional modules 110-1 to 110-N to allow one of the first to Nth functional modules 110-1 to 110-N to access the display memory 200. Therefore, the memory controller 300 performs interface processing between the display memory 200 and the memory controller 300. The memory controller 300 also performs interface processing between each of the first to Nth functional modules 110-1 to 110-N and the memory controller 300. This makes it possible to use a general-purpose memory interface as the interface of the display memory 200 irrespective of the interface of each functional module, and allows the display memory 200 to be accessed from the functional modules through such a general-purpose memory interface.

Each of the first to Nth functional modules 110-1 to 110-N issues an access request (write request or read request) to the memory controller 300, and the memory controller 300 returns an access acknowledgment (write acknowledgment or read acknowledgment) for the access request. Specifically, the first to Nth functional modules 110-1 to 110-N and the memory controller 300 exchange signals by a handshake method.

The memory controller 300 arbitrates between the access requests (write request or read request) from the first to Nth functional modules 110-1 to 110-N. When two or more of the first to Nth functional modules 110-1 to 110-N have issued access requests for the display memory 200 at the same time, the memory controller 300 arbitrates between the access requests, and allows access corresponding to the access request from the functional module which is permitted to access the display memory 200 as a result of arbitration.

Specifically, the functional module outputs an access request Req (write request WRReq or read request RDReq), synchronization signals (signals which specify a vertical display period and a horizontal display period), and data (during writing) to the memory controller 300. When the memory controller 300 has received the access request Req, the synchronization signals, and the like, the memory controller 300 returns an access acknowledgment Ack (write acknowledgment WRAck or read acknowledgment RDAck) to the functional module which has issued the access request. The memory controller 300 then controls access to the display memory 200 by arbitrating between the access requests from the first to Nth functional modules 110-1 to 110-N, generating an access address (write address or read address) of the display memory 200 corresponding to the access request from one of the first to Nth functional modules 110-1 to 110-N, and outputting the access address, access control signal, and data (if necessary) to the display memory 200.

In the image processing controller 100, the first to Nth functional modules 110-1 to 110-N which issue the access request merely transmit the access request Req and data without generating the access address for accessing the display memory 200, as described above. Therefore, the functional module can perform the next operation immediately after issuing the access request for the display memory 200. This reduces unnecessary operating time of the functional module during the access operation for the display memory 200, whereby the throughput of the processing can be improved.

2. Memory Controller

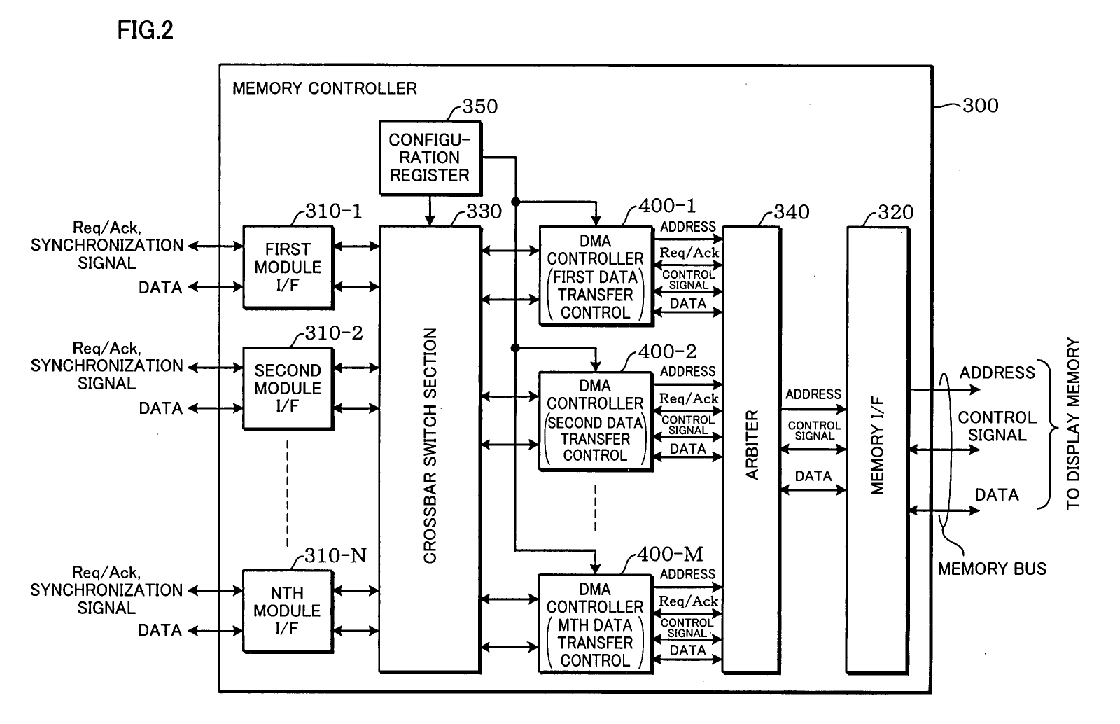

FIG. 2 is a block diagram of an outline of a configuration of the memory controller 300 shown in FIG. 1.

Note that the memory controller 300 need not necessarily include all the blocks shown in FIG. 2. The memory controller 300 may have a configuration in which at least one of the blocks shown in FIG. 2 is omitted.

The memory controller 300 includes first to Nth module interfaces (hereinafter abbreviated as “I/F”) 310-1 to 310-N and a memory I/F 320. The first to Nth module I/Fs 310-1 to 310-N are respectively connected with the first to Nth functional modules 110-1 to 110-N, and perform interface processing between the functional module and the memory controller 300. The memory I/F 320 performs interface processing between the display memory 200 and the memory controller 300.

The memory controller 300 includes direct memory access (DMA) controllers 400-1 to 400-M (1<M≦N, M is an integer) (first to Mth data transfer control sections), a crossbar switch section 330, and an arbiter 340.

Each of the DMA controllers 400-1 to 400-M issues a data transfer request for the display memory 200 corresponding to the access request supplied to each DMA controller. The crossbar switch section 330 supplies the access request from one of the first to Nth functional modules 110-1 to 110-N to one of the DMA controllers 400-1 to 400-M. The arbiter 340 arbitrates between the data transfer requests from the DMA controllers 400-1 to 400-M. The memory I/F 320 performs interface processing for accessing the display memory 200 based on the data transfer request from one of the DMA controllers 400-1 to 400-M determined as a result of arbitration by the arbiter 340.

The DMA controller generates an access address of the display memory 200 based on the access request supplied to the DMA controller. When the data transfer request for the display memory 200 has been permitted as a result of arbitration by the arbiter 340, the DMA controller controls reading of image data from the display memory 200 or writing of image data into the display memory 200 using the access address.

The memory controller 300 may include a configuration register 350. A host (not shown) sets data in the configuration register 350. The crossbar switch section 330 controls switch connection based on the data set in the configuration register 350 so that the access request from one of the first to Nth module I/Fs 310-1 to 310-N is supplied to one of the DMA controllers 400-1 to 400-M. In the DMA controllers 400-1 to 400-M, based on the data set in the configuration register 350, the data transfer direction (write or read) is determined, and the start address and the address update unit are determined so that the access address is generated.

The data can be transferred to or from the display memory 200 corresponding to the access request from the functional module irrespective of the number of functional modules by providing the crossbar switch section 330 of which the switch connection is controlled using the configuration register 350. Moreover, a functional module can be easily added.

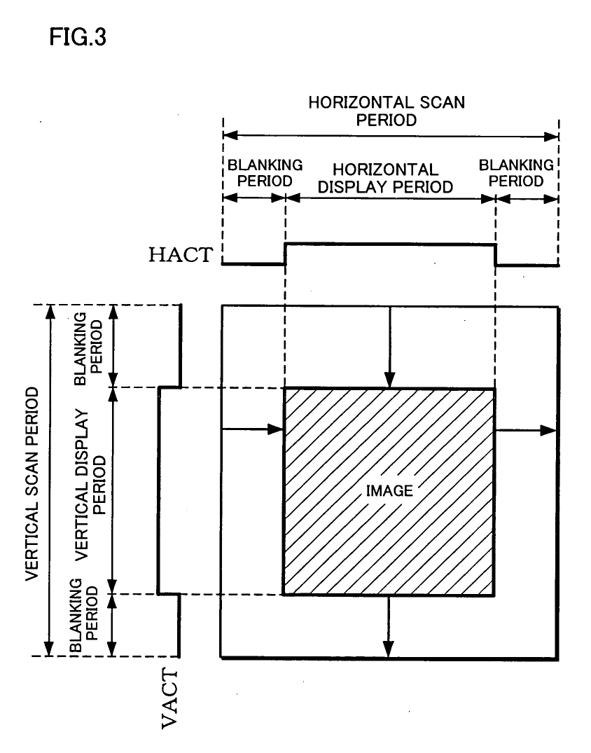

FIG. 3 is a diagram illustrative of the synchronization signals according to this embodiment.

The synchronization signals according to this embodiment include synchronization signals VACT and HACT. The synchronization signal VACT is a signal which specifies the vertical display period of an image and is set to active in a period in which the horizontal display period is valid. Therefore, one vertical scan period can also be specified by the synchronization signal VACT. The vertical display period is a period including an image valid line (line including valid pixels (display pixels)).

The synchronization signal HACT is a signal which specifies the horizontal display period of an image and is set to active in a period in which image data is valid. Therefore, one horizontal scan period can also be specified by the synchronization signal HACT. The horizontal scan period is a period including valid pixels (display pixels) of an image of one line.

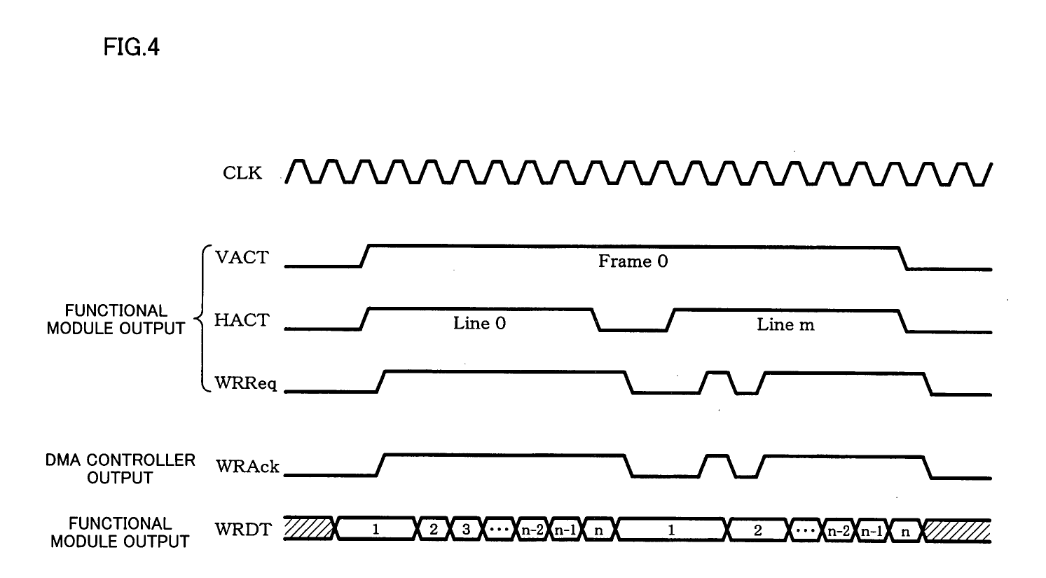

FIG. 4 shows an example of an operation timing when the functional module issues the write request to the DMA controller in this embodiment.

FIG. 4 shows a timing example in which the crossbar switch section 330 outputs the write request from the first functional module 110-1 to the DMA controller 400-M based on the data set in the configuration register 350.

The first functional module 110-1 sets the synchronization signals VACT and HACT to active in synchronization with a system clock signal CLK. The first functional module 110-1 sets the write request WRReq supplied to the DMA controller 400-M to active, and outputs write data WRDT. The synchronization signals VACT and HACT and the write request WRReq are supplied to the DMA controller 400-M from the crossbar switch section 330 as the data transfer request from the first functional module 110-1.

The DMA controller 400-M queues the synchronization signals VACT and HACT, the write request WRReq, and the write data WRDT, sets the write acknowledgment WRAck to active when the write request WRReq has been set to active, and returns the active write acknowledgment WRAck to the first functional module 110-1. The DMA controller 400-M queues the write data WRDT when the synchronization signals VACT and HACT are set to active. When the write data has been completely queued, the first functional module 110-1 sets the synchronization signal HACT to inactive, and then sets the write request WRReq to inactive. The DMA controller 400-M which has received the inactive write request WRReq sets the write acknowledgment WRAck to inactive, and returns the inactive write acknowledgment WRAck to the first functional module 110-1. The first functional module 110-1 thus issues the write request for the image data of one frame to the DMA controller 400-M.

After the write acknowledgment WRAck has been set to inactive in a state in which the synchronization signals VACT and HACT and the write request WRReq are set to inactive, the first functional module 110-1 can perform the next operation without waiting for completion of writing of the write request target data into the display memory 200.

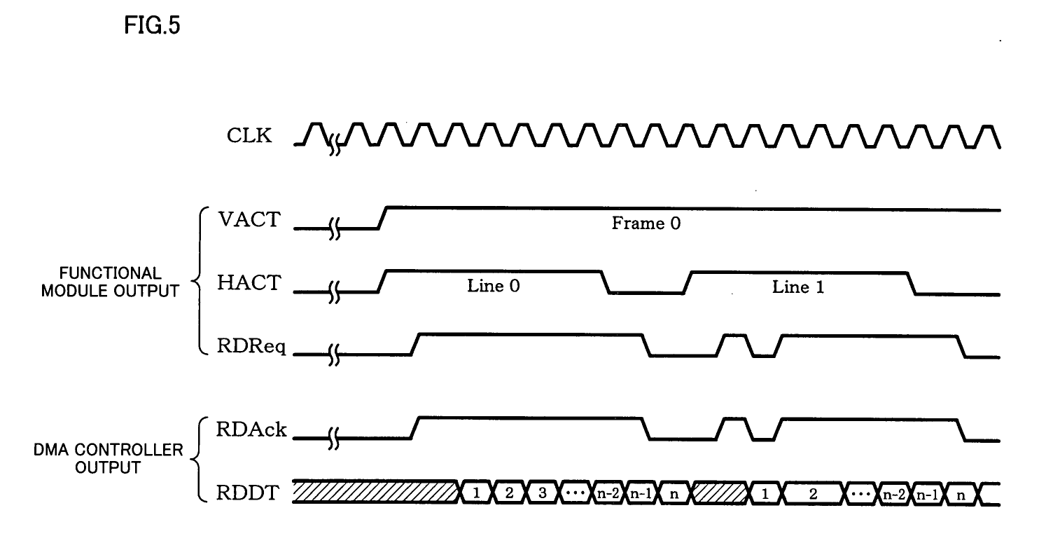

FIG. 5 shows an example of an operation timing when the functional module issues the read request to the DMA controller in this embodiment.

FIG. 5 shows a timing example in which the crossbar switch section 330 outputs the read request from the first functional module 110-1 to the DMA controller 400-M based on the data set in the configuration register 350.

The first functional module 110-1 sets the synchronization signals VACT and HACT to active in synchronization with the system clock signal CLK, and sets the read request RDReq supplied to the DMA controller 400-M to active. The synchronization signals VACT and HACT and the read request RDReq are supplied to the DMA controller 400-M from the crossbar switch section 330 as the data transfer request from the first functional module 110-1.

When the read request RDReq has been set to active, the DMA controller 400-M sets the read acknowledgment RDAck to active. The DMA controller 400-M outputs the read data, which has been read from the display memory 200 and held based on the data set in the configuration register 350, in synchronization with the synchronization signals VACT and HACT.

The first functional module 110-1 thus issues the read request for the image data of one frame to the DMA controller 400-M. The first functional module 110-1 reads the read data which has been read in advance in response to the read acknowledgment RDAck. Therefore, the first functional module 110-1 can promptly perform the next operation since the period in which the first functional module 110-1 waits for the read data to be output after issuing the read request RDReq is reduced.

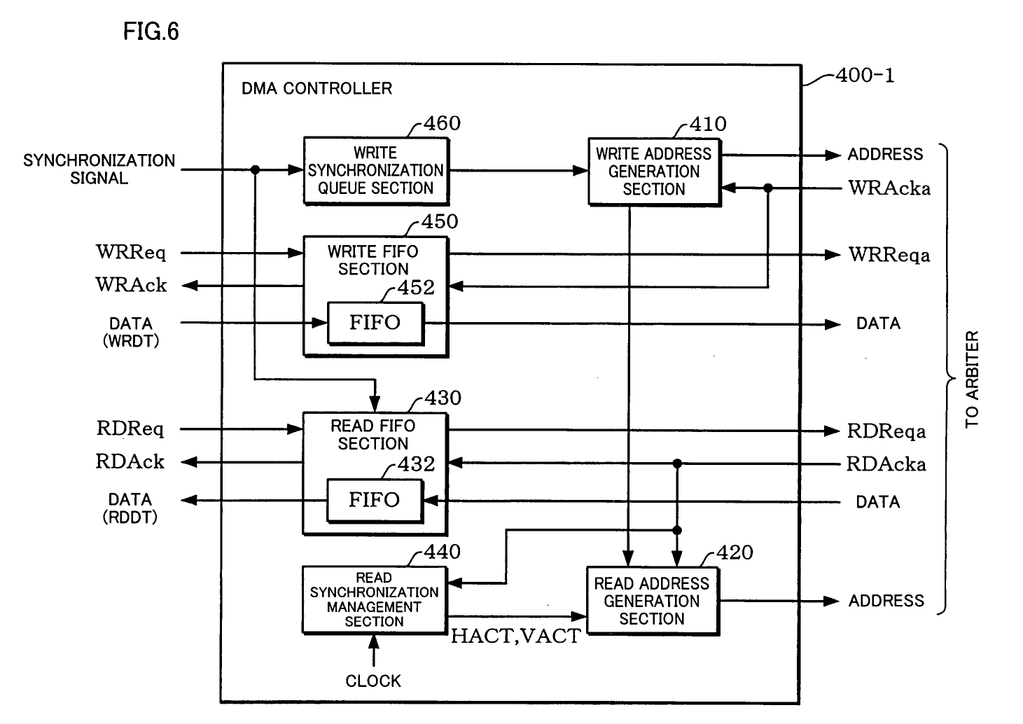

FIG. 6 is a block diagram of a configuration example of the DMA controller 400-1 shown in FIG. 2. FIG. 6 shows the configuration of the DMA controller 400-1 among the DMA controllers 400-1 to 400-M. Note that the configurations of the DMA controller 400-2 to 400-M are the same as the configuration of the DMA controller 400-1.

Note that the DMA controller 400-1 need not necessarily include all the blocks shown in FIG. 6. The DMA controller 400-1 may have a configuration in which at least one of the blocks shown in FIG. 6 is omitted.

The DMA controller 400-1 includes a write address generation section 410 and a read address generation section 420. In this embodiment, a functional module which issues the write request to the write address generation section 410 and a functional module which issues the read request to the read address generation section 420 can be independently set. These functional modules are set based on the data set in the configuration register 350.

The write address generation section 410 generates the write address for writing image data into the display memory 200 as the access address. The read address generation section 420 generates the read address for reading image data from the display memory 200 as the access address.

In this embodiment, the DMA controller 400-1 accesses the display memory 200 by an access method called a double buffering method or a triple buffering method. Specifically, the DMA controller 400-1 accesses data using two or more areas set in the storage area of the display memory 200. In more detail, when accesses (read access and write access) for image data of one frame continuously occur, the DMA controller 400-1 accesses the display memory 200 while changing the access target storage area.

The write address generation section 410 generates the write address and write area information which designates the storage area of the display memory 200 into which the image data is written, for example. The write area information may be generated based on the data set in the configuration register 350.

The read address generation section 420 generates the read address for reading data from an area of the display memory 200 differing from the area designated by the write area information from the write address generation section 410.

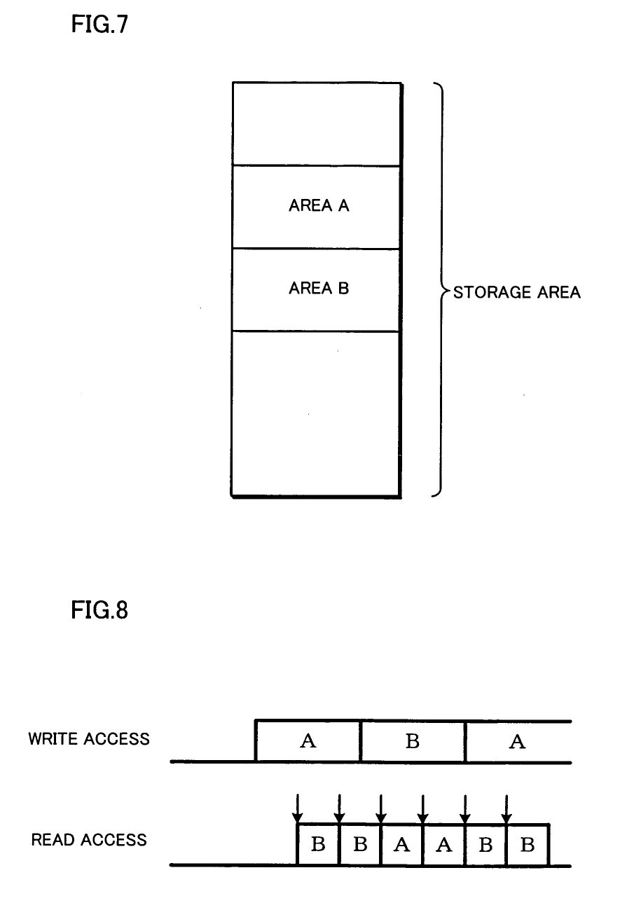

FIG. 7 is a diagram illustrative of the storage area of the display memory 200.

As shown in FIG. 7, two areas A and B are set in the storage area of the display memory 200, for example. The DMA controller 400-1 accesses the display memory 200 by the double buffering method using the areas A and B of the display memory 200.

FIG. 8 is a diagram illustrative of the access from the DMA controller 400-1 by the double buffering method.

For example, when a read request occurs in a period in which a write request for the area A occurs, the read address generation section 420 generates the read address of the area B. When a read request occurs in a period in which a write request for the area B occurs, the read address generation section 420 generates the read address of the area A.

Therefore, it is unnecessary for the functional module to distinguish the area of the display memory 200 when accessing the display memory 200 by the double buffering method, whereby the functional module need not know the buffering method. In the case where the functional module distinguishes the area of the display memory 200, the functional module must distinguish the area based only on the access request even if the area has not been accessed. Therefore, the functional module may access an area differing from the area the functional module should access.

In FIG. 6, the DMA controller 400-1 may include a read FIFO section (read data queue) 430 and a read synchronization management section 440. Image data read from the display memory 200 is queued in the read FIFO section 430. The read synchronization management section 440 generates the synchronization signals VACT and HACT (synchronization signals specifying the horizontal scan period and the vertical scan period of an image expressed by image data). In more detail, the read synchronization management section 440 generates the synchronization signals VACT and HACT by counting the number of pixels of image data read from the display memory 200. In further detail, the read synchronization management section 440 counts the number of pixels of image data based on the read acknowledgment RDAcka corresponding to the read request RDReqa from the DMA controller 400-1 to the arbiter 340. The read address generation section 420 generates the read address which is updated based on the synchronization signals VACT and HACT generated by the read synchronization management section 440.

The DMA controller 400-1 may include a write FIFO section (write data queue) 450 and a write synchronization queue section 460. Image data written into the display memory 200 is queued in the write FIFO section 450. The synchronization signals VACT and HACT (synchronization signals specifying the horizontal display period and the vertical display period of an image expressed by image data written into the display memory 200) are queued in the write synchronization queue section 460.

The write address generation section 410 generates the write address which is updated corresponding to the queuing state of the write FIFO section 450 after the start timing of the vertical display period determined based on the synchronization signal VACT queued in the write synchronization queue section 460. The write address generation section 410 generates the write address which is updated to an address for writing image data in the next horizontal display period at an end timing of the horizontal display period determined based on the synchronization signal HACT queued in the write synchronization queue section 460.

As the synchronization signal queued in the write synchronization queue section 460, it is preferable to queue one-bit start information and one-bit end information respectively indicating the start timing and the end timing of at least one of the horizontal display period and the vertical display period. This reduces the amount of information of the synchronization signal which must be queued in the write synchronization queue section 460.

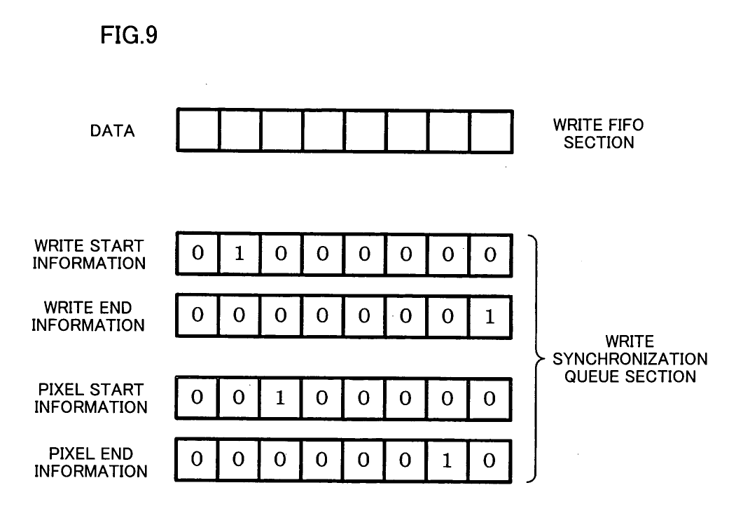

FIG. 9 is a diagram illustrative of the write FIFO section 450 and the write synchronization queue section 460.

The write FIFO section 450 includes a first-in first-out (FIFO) section 452 having a first-in first-out function. Image data having a number of bytes corresponding to the width of the data bus of the display memory 200 is held in each stage of the FIFO section 452.

The read FIFO section 430 shown in FIG. 6 includes a FIFO section 432. Image data having a number of bytes corresponding to the width of the data bus of the display memory 200 is held in each stage of the FIFO section 432.

The write synchronization queue section 460 is also a memory having a first-in first-out function. The synchronization signal corresponding to each stage of the FIFO section 452 of the write FIFO section 450 is held in each stage of the write synchronization queue section 460.

Specifically, image data in an amount corresponding to a specific number of blocks is queued in the write FIFO section 450, each of the blocks containing data in an amount corresponding to the width of the data bus of the display memory 200 and the burst length. The synchronization signal is queued in the write synchronization queue section 460 in block units.

As the synchronization signal, line start information indicating “1” at a rising edge of the synchronization signal VACT, line end information indicating “1” at a falling edge of the synchronization signal VACT, pixel start information indicating “1” at a rising edge of the synchronization signal HACT, and pixel end information indicating “1” at a falling edge of the synchronization signal HACT are queued.

The image data queued in the write FIFO section 450 and the synchronization signal queued in the write synchronization queue section 460 are output in synchronization each time the write acknowledgment WRAcka is returned to the write request WRReqa.

The write address generation section 410 distinguishes the vertical display period shown in FIG. 3 based on the line start information and the line end information. The write address generation section 410 distinguishes the horizontal display period shown in FIG. 3 based on the pixel start information and the pixel end information. On the other hand, the read address generation section 420 distinguishes the vertical display period and the horizontal display period shown in FIG. 3 based on the synchronization signals VACT and HACT generated by the read synchronization management section 440.

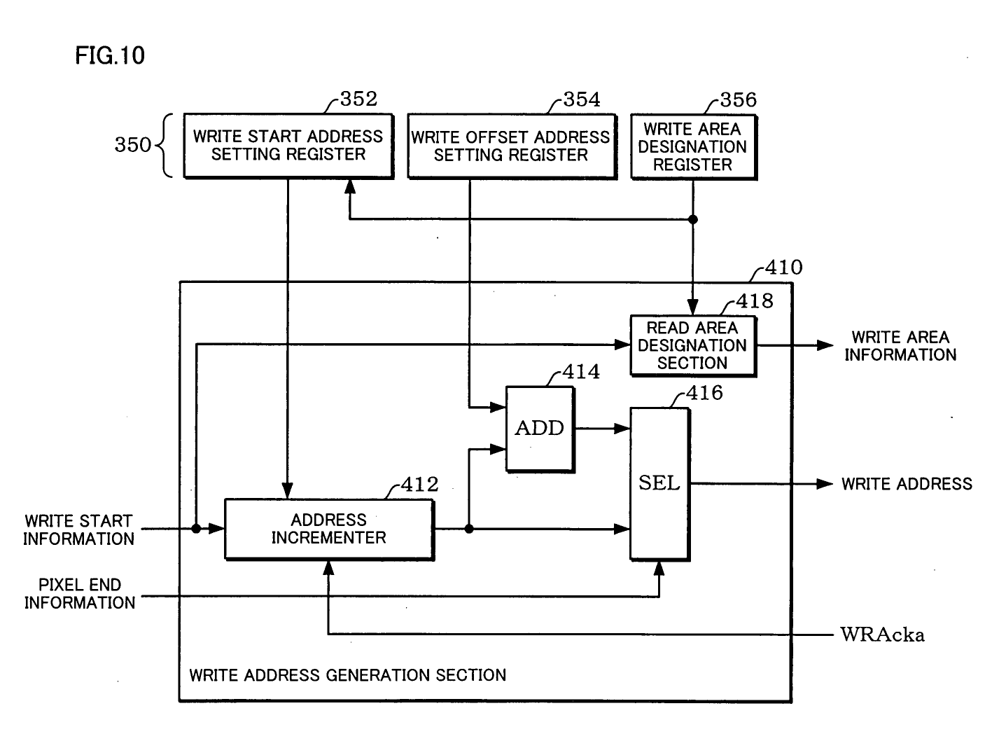

FIG. 10 is a block diagram of a configuration example of the write address generation section 410 shown in FIG. 6.

The write address generation section 410 may include an address incrementer 412, an adder 414, a selector 416, and a read area designation section 418.

A write start address set in a write start address setting register 352 of the configuration register 350 is loaded into the address incrementer 412 when the line start information has become “1”. The address incrementer 412 updates the address each time the write acknowledgment WRAcka is returned.

The output from the address incrementer 412 is input to the adder 414. A write offset address set in a write offset address setting register 354 of the configuration register 350 is also input to the adder 414. The adder 414 adds the output from the address incrementer 412 and the write offset address.

The selector 416 outputs the output from the address incrementer 412 as the write address when the pixel end information is “0”, and outputs the output from the adder 414 as the write address when the pixel end information is “1”.

As a result, the selector 416 loads the write start address when the line start information has become “1”, and then updates the write address. When the pixel end information has become “1”, the selector 416 finishes updating the write address of one line, and outputs an address obtained by adding the write offset address to the current write address as the head address of the next line.

The read area designation section 418 designates the area of the display memory 200 differing from the write area as the read area while sequentially changing the area based on the line start information, and outputs the write area information to the read address generation section 420. For example, when using two areas of the display memory 200, the read area designation section 418 switches (toggles) the read area based on the line start information, and outputs the write area information corresponding to the toggle result.

The write area designated in a write area designation register 356 of the configuration register 350 may be supplied to the read area designation section 418. In this case, in order to designate the area of the display memory 200 differing from the write area as the read area, the read area designation section 418 outputs the write area information to the read address generation section 420.

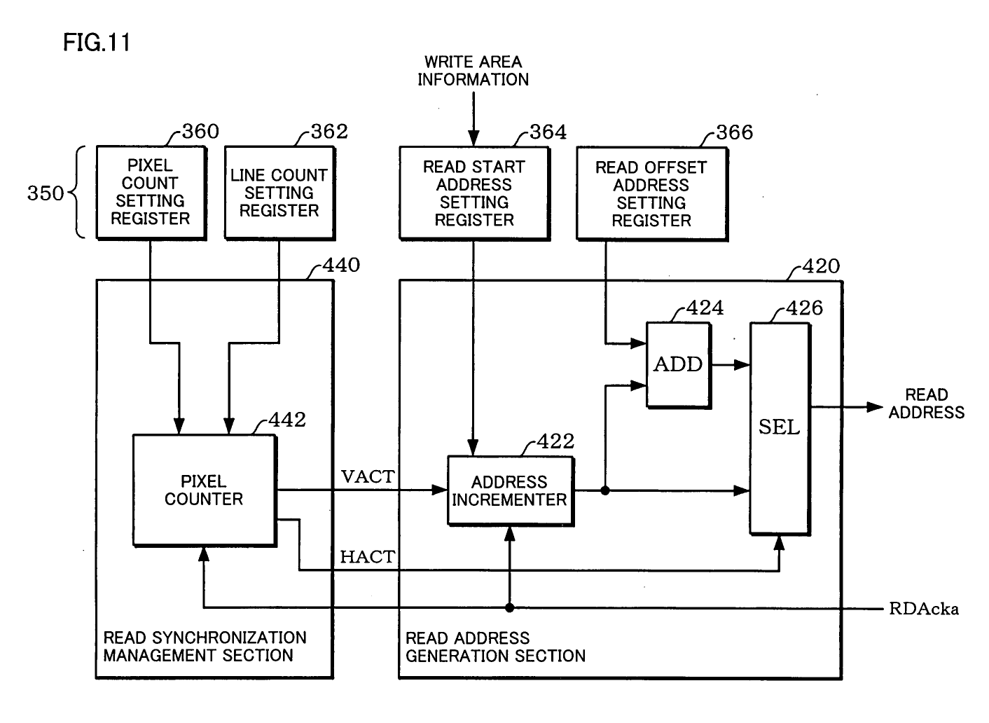

FIG. 11 is a block diagram of a configuration example of the read address generation section 420 shown in FIG. 6.

FIG. 11 also shows the read synchronization management section 440 which generates the synchronization signals VACT and HACT in addition to the read address generation section 420. The read synchronization management section 440 includes a pixel counter 442. The pixel counter 442 increments the count value each time the read acknowledgment RDAcka for the read request RDReqa is returned based on data set in a pixel count setting register 360 and a line count setting register 362 of the configuration register 350, and generates the synchronization signals VACT and HACT.

In more detail, the number of pixels of one line or a value corresponding to the number of pixels is set in the pixel count setting register 360. The number of lines of an image or a value corresponding to the number of lines is set in the line count setting register 362. The pixel counter 442 generates the synchronization signals VACT and HACT corresponding to the vertical display period and the horizontal display period shown in FIG. 3 while reading the image data from the display memory 200 based on the number of lines of the image and the number of pixels of one line. The synchronization signals VACT and HACT are supplied to the read address generation section 420.

The read address generation section 420 may include an address incrementer 422, an adder 424, and a selector 426.

The read start address set in a read start address setting register 364 of the configuration register 350 is loaded into the address incrementer 422 at a rising edge (inactive to active) of the synchronization signal VACT from the read synchronization management section 440. The address incrementer 422 updates the address each time the read acknowledgment RDAcka is returned.

The output from the address incrementer 422 is input to the adder 424. A read offset address set in a read offset address setting register 366 of the configuration register 350 is also input to the adder 424. The adder 424 adds the output from the address incrementer 422 and the read offset address.

The selector 426 outputs the output from the address incrementer 422 as the read address when the synchronization signal HACT is set to active, and outputs the output from the adder 424 as the read address at a falling edge (active to inactive) of the synchronization signal HACT.

As a result, the selector 426 loads the read start address when the synchronization signal VACT has changed to active, and then updates the read address. When the synchronization signal VACT has changed to inactive, the selector 426 finishes updating the read address of one line, and outputs an address obtained by adding the read offset address to the current read address as the head address of the next line.

The read start address for reading the image data from the area of the display memory 200 differing from the area designated by the write area information from the write address generation section 410 is output from the read start address setting register 364.

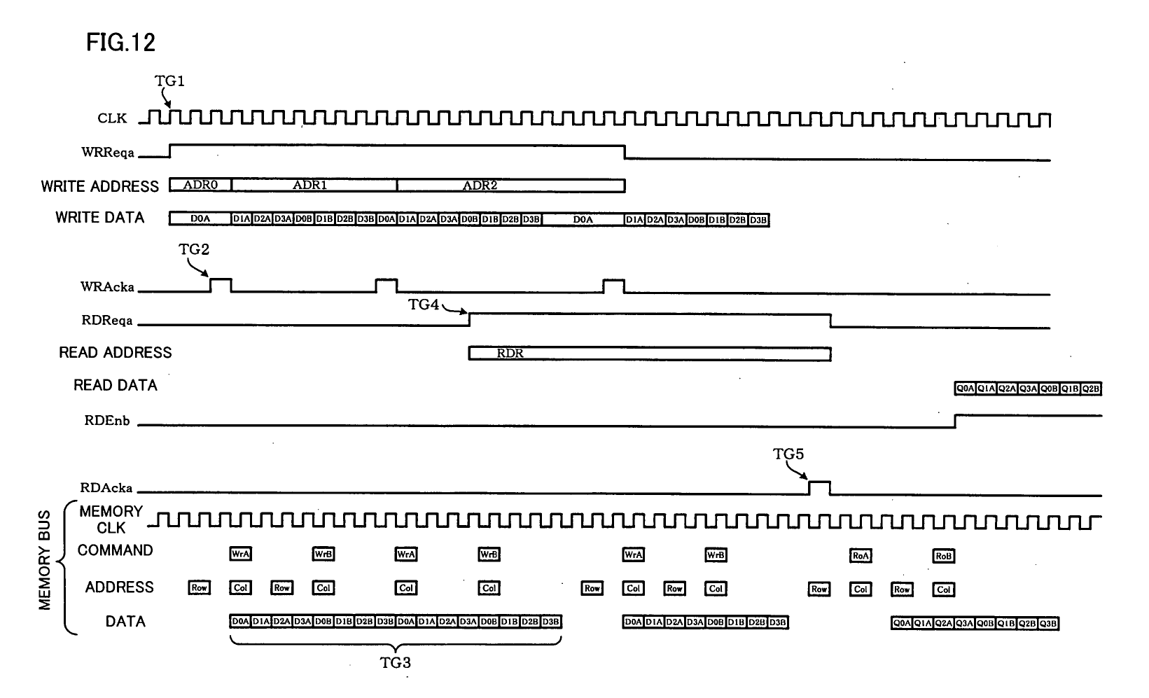

FIG. 12 shows a timing example of the signals exchanged between the DMA controller 400-1 and the arbiter 340 according to this embodiment.

FIG. 12 shows an example in which a read access occurs after three write accesses have continuously occurred. FIG. 12 shows a timing diagram of the signals exchanged between the DMA controller 400-1 and the arbiter 340. Note that the timing of the signals exchanged between each of the DMA controllers 400-2 to 400-M and the arbiter 340 is the same as shown in FIG. 12.

In the following description, data or a command to which “A” is attached at the end relates to access to an area A set in the display memory 200, and data or a command to which “B” is attached at the end relates to access to an area B set in the display memory 200 (“A” and “B” mentioned below differ from the areas A and B described with reference to FIGS. 7 and 8).

The DMA controller 400-1 sets the write request WRReqa to active, and outputs a write address ADR0 and write data DOA (TG1).

The arbiter 340 returns the write acknowledgment WRAcka in response to the write request WRReqa from the DMA controller 400-1 (TG2), and the DMA controller 400-1 updates the write address to “ADR1” and sequentially outputs write data D1A, D2A, . . . .

The memory I/F 320 sequentially writes the write data into the display memory 200 based on the write address from the DMA controller 400-1. In more detail, the memory I/F 320 outputs the row address and the column address of the display memory 200 based on the write address, and outputs a command corresponding to the combination of the control signals to realize access to the display memory 200 (TG3).

The DMA controller 400-1 generates the read request RDReqa during the third write operation (TG4). The DMA controller 400-1 outputs the read address RDR together with the read request RDReqa.

When the write acknowledgment WRAcka for the third write request WRReqa has been returned, the arbiter 340 returns the read acknowledgment RDAcka in response to the read request RDReqa (TG5). Therefore, the memory I/F 320 performs a write access after the third write acknowledgment WRAcka has been returned, and then performs a read access.

In the read operation, the read data is latched by the FIFO section 432 of the read FIFO section 430 in response to a signal RDEnb which is set to active when the read data is supplied.

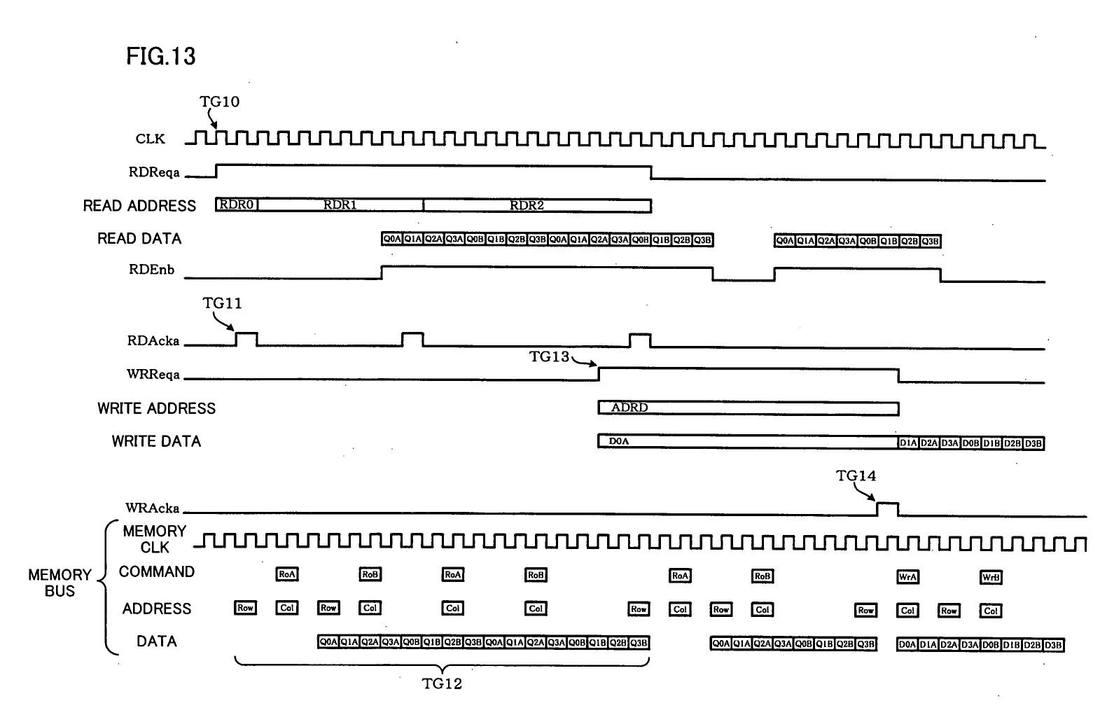

FIG. 13 shows another timing example of the signals exchanged between the DMA controller 400-1 and the arbiter 340 according to this embodiment.

FIG. 13 shows an example in which a write access occurs after three read accesses have continuously occurred. FIG. 13 shows a timing diagram of the signals exchanged between the DMA controller 400-1 and the arbiter 340. Note that the timing of the signals exchanged between each of the DMA controllers 400-2 to 400-M and the arbiter 340 is the same as shown in FIG. 13.

The DMA controller 400-1 sets the read request RDReqa to active, and outputs a read address RDR0 (TG10). The arbiter 340 returns the read acknowledgment RDAcka in response to the read request RDReqa (TG11). The DMA controller 400-1 which has received the read acknowledgment RDAcka updates the read address.

The memory I/F 320 sequentially reads data from the display memory 200 based on the read address RDR0. In more detail, the memory I/F 320 outputs the row address and the column address of the display memory 200 based on the read address, and outputs a command corresponding to a combination of the control signals to realize access to the display memory 200 (TG12).

The DMA controller 400-1 generates the write request WRReqa during the third read operation (TG13). The DMA controller 400-1 outputs the write address ADR0 together with the write request WRReqa.

When the read acknowledgment RDAcka for the third read request RDReqa has been returned and the third read access has been completed, the arbiter 340 returns the write acknowledgment WRAcka in response to the write request WRReqa (TG14). Therefore, the memory I/F 320 performs a write access after the write acknowledgment WRAcka has been returned.

As described above, according to this embodiment, a memory controller can be provided which improves the throughput of data transfer requested by each functional module irrespective of the number of functional modules while using a general-purpose memory interface.

Specifically, since the memory controller 300 generates the access address instead of the functional module, a problem can be prevented in which the functional module cannot transition to the next operation immediately after outputting the access address when the functional module accesses the display memory 200 by the handshake method.

According to this embodiment, since each DMA controller queues data and the like, the access request from each functional module and arbitration between the access requests for the display memory 200 occur at different timings. As a result, the blanking period of the image for which the display memory 200 is accessed differs in time from the blanking period of the image displayed on an LCD panel or the like. Therefore, according to this embodiment, data transfer to and from the display memory 200 is also performed substantially in the blanking period of the image displayed on an LCD panel or the like, whereby the throughput of data transfer is improved.

Moreover, the memory controller 300 includes the DMA controllers, and the access request from the functional module can be supplied to one of the DMA controllers by the crossbar switch section 330. Therefore, signals necessary for arbitration when the DMA controllers have issued the access requests for the display memory 200 at the same time can be exchanged inside the memory controller 300. This makes it unnecessary to additionally provide a signal line for a signal exchanged between the functional modules when adding a functional module, and facilitates addition of a functional module, whereby a memory controller with high extensibility can be provided.

The DMA controller provided in the memory controller 300 includes the write address generation section and the read address generation section. The address generation section independently receives the access request from the functional module, and the read address generation section generates the read address by referring to the write area information accessed by the write address generation section. Therefore, when the functional module accesses the display memory 200 by the double buffering method or the triple buffering method, the DMA controller nearer to the display memory 200 than the functional module can distinguish the area of the display memory 200 using the write area information of the latest write access.

3. Display Controller Application Example

An example in which the image processing controller 100 according to this embodiment is applied to a display controller is described below.

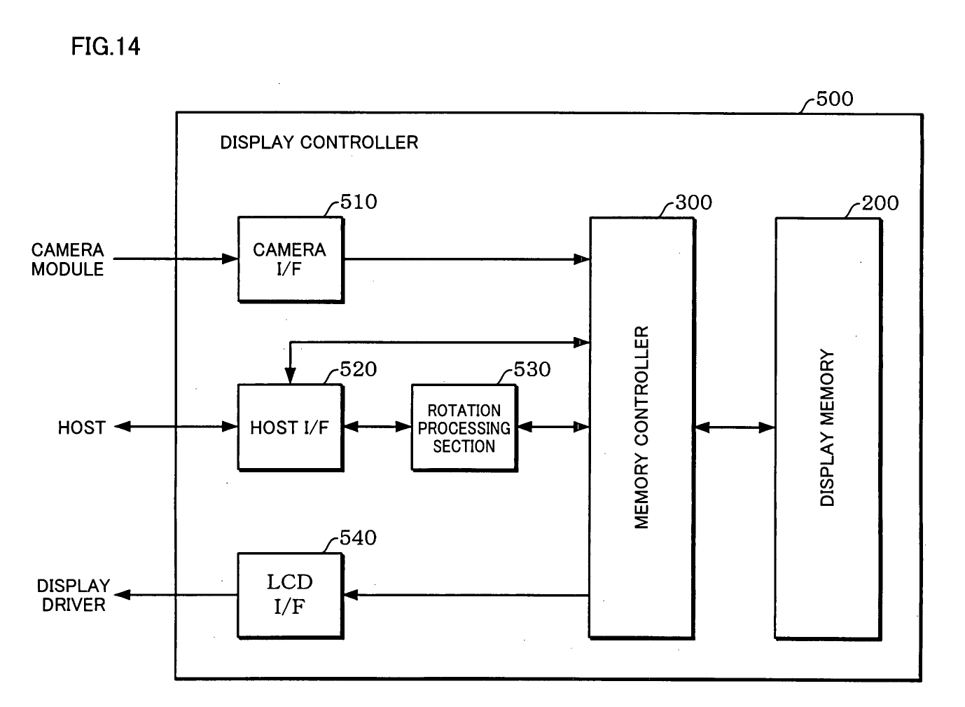

FIG. 14 is a block diagram of a configuration example of a display controller to which the image processing controller 100 according to this embodiment is applied. In FIG. 14, the same sections as the sections shown in FIG. 1 are indicated by the same symbols. Description of these sections is appropriately omitted.

A display controller (image processing controller in a broad sense) 500 includes the display memory 200, the memory controller 300, a camera I/F (image data input I/F in a broad sense) 510, a host I/F 520, a rotation processing section 530, and an LCD I/F (image data output I/F in a broad sense) 540.

Image data is input to the camera I/F 510. In more detail, data of an image captured using a camera module including a CCD camera or a CMOS camera is input to the camera I/F 510. The camera I/F 510 performs interface processing (reception from the camera module or signal buffering) of the image data, and issues to the memory controller 300 a write request for writing the image data after the interface processing into the display memory 200.

A host (not shown) inputs data to the host I/F 520. The host I/F 520 performs interface processing (reception from the host or signal buffering), and issues a write request for writing the data after the interface processing into the display memory 200, or supplies the data after the interface processing to the rotation processing section 530. The host I/F 520 issues a read request for reading image data from the display memory 200, or outputs image data after rotation processing output from the rotation processing section 530 to the host. In this case, the host I/F 520 outputs the data after interface processing (transmission to the host or signal buffering) to the host.

The rotation processing section 530 rotates an image around the center position of the image (rotation processing), for example. In more detail, the rotation processing section 530 issues to the memory controller 300 a write request for writing image data after the rotation processing into the display memory 200, or issues to the memory controller 300 a read request for reading image data from the display memory 200 so that the image read from the display memory 200 is rotated around the center position of the image.

The LCD I/F 540 performs interface processing for outputting image data read from the display memory 200 as a result of read access control by the memory controller 300. The LCD I/F 540 performs interface processing (transmission to a display driver or signal buffering) of image data from the memory controller 300, and outputs the image data after the interface processing to the display driver (not shown). The LCD I/F 540 includes a synchronization signal generation circuit (not shown), for example. The LCD I/F 540 generates display synchronization signals (e.g. vertical synchronization signal VSYNC which specifies one vertical scan period (i.e. scan period of one frame), horizontal synchronization signal HSYNC which specifies one horizontal scan period, and dot clock signal DCLK) for driving an electro-optical device, and supplies the synchronization signals to the display driver. The LCD I/F 540 outputs image data of each frame in synchronization with the vertical synchronization signal, and outputs image data of each pixel in synchronization with the dot clock signal.

In the display controller 500, the rotation processing is performed for image data input through the camera I/F 510, and the image data after the rotation processing is output through the LCD I/F 540.

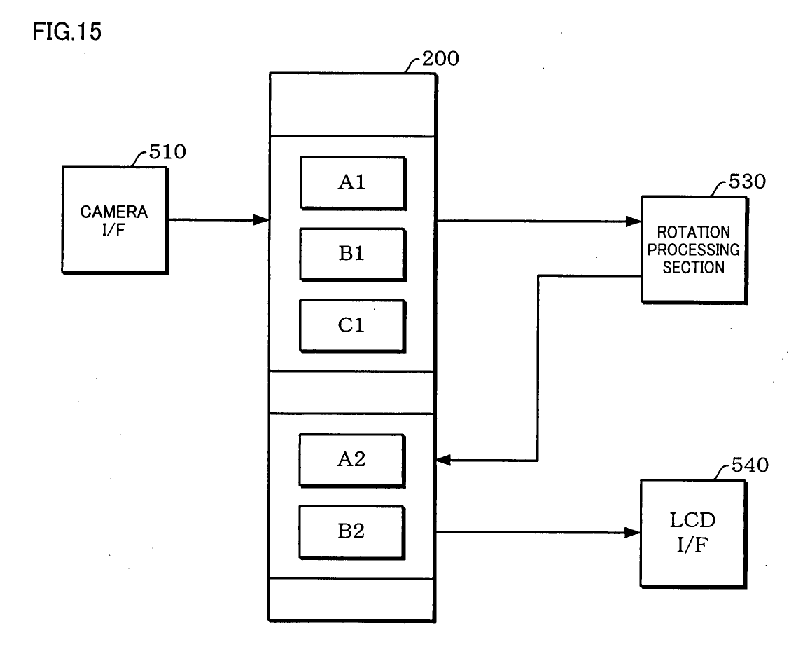

FIG. 15 schematically shows an operation example of the display controller 500 shown in FIG. 14.

In general, when two blocks access the display memory 200, data subjected to writing is prevented from being erroneously read by accessing the display memory 200 using the double buffering method. However, when performing the rotation processing, it is necessary to read image data of each pixel arranged in the vertical direction of the image as image data of each pixel arranged in the horizontal direction of the image, for example. Therefore, the camera I/F 510 and the rotation processing section 530 request access to the display memory 200 using the triple buffering method.

Specifically, the camera I/F 510 and the rotation processing section 530 access the display memory 200, which stores image data of three frames in a triple buffer area, for image data of different frames.

On the other hand, when the rotation processing section 530 writes the image data after the rotation processing into the display memory 200, the rotation processing section 530 need not access the display memory 200 using the triple buffering method. Therefore, the rotation processing section 530 and the LCD I/F 540 request access to the display memory 200 using the double buffering method.

Specifically, the LCD I/F 540 and the rotation processing section 530 access the display memory 200, which stores image data of two frames in a double buffer area, for image data of different frames.

In the memory controller 300 of the display controller 500, it is preferable that the write access from the camera I/F 510 be realized by the write channel of the DMA controller 400-1 and the read access from the rotation processing section 530 be realized by the read channel of the DMA controller 400-1. This makes it unnecessary to wait for completion of access based on the write area information, even if the write request and the read request for the triple buffer area have occurred at the same time.

In the memory controller 300 of the display controller 500, it is preferable that the write access from the rotation processing section 530 be realized by the write channel of the DMA controller 400-2 and the read access from the LCD I/F 540 be realized by the read channel of the DMA controller 400-2.

4. Electronic Instrument

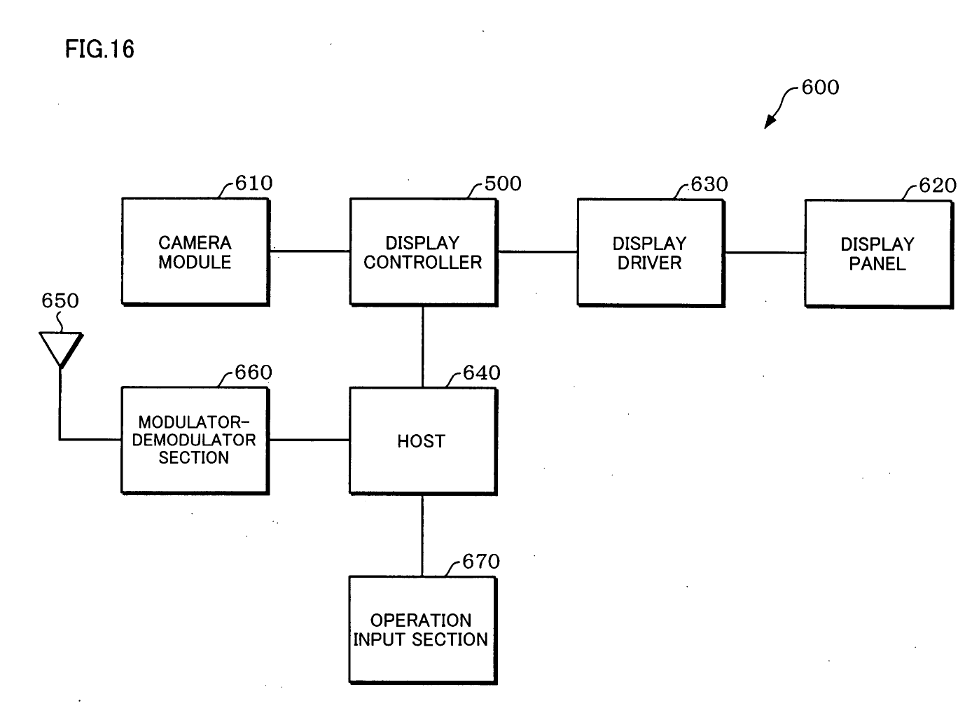

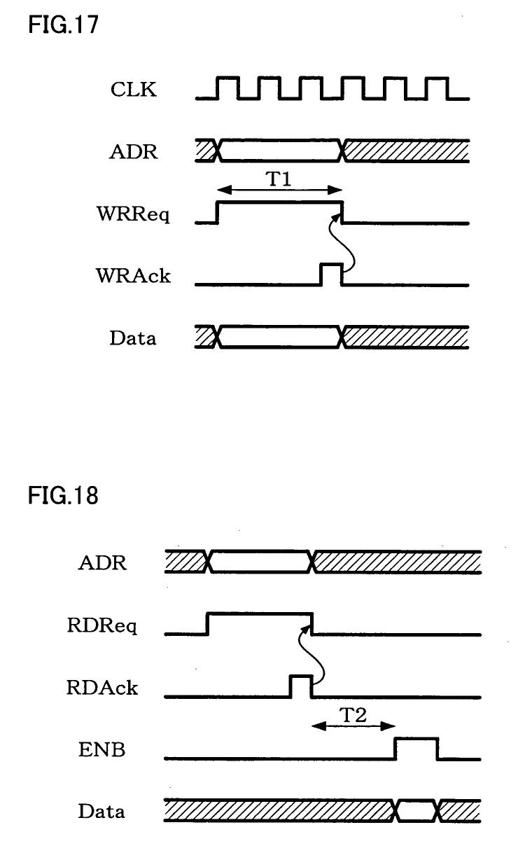

FIG. 16 is a block diagram of a configuration example of an electronic instrument according to one embodiment of the invention. FIG. 16 is a block diagram of a configuration example of a portable telephone as an example of the electronic instrument.

A portable telephone 600 includes the display controller 500 shown in FIG. 14. The portable telephone 600 includes a camera module 610. The camera module 610 includes a CCD camera, and supplies data of an image captured using the CCD camera to the display controller 500.

The portable telephone 600 includes a display panel (electro-optical device in a broad sense; display device in a broader sense) 620. An LCD panel may be used as the display panel 620. In this case, the display panel 620 is driven by a display driver 630. The display panel 620 includes scan lines, data lines, and pixels. The display driver 630 has the function of a scan driver which selects the scan lines in units of one or more scan lines, and the function of a data driver which supplies a voltage corresponding to pixel data to the data lines.

The display controller 500 is connected with the display driver 630, and supplies image data in the RGB format to the display driver 630.

A host 640 is connected with the display controller 500. The host 640 controls the display controller 500. The host 640 demodulates communication data including image data received through an antenna 650 using a modulator-demodulator section 660, and supplies the demodulated data to the display controller 500. The display controller 500 causes the display driver 630 to display an image on the display panel 620 based on the image data.

The host 640 modulates image data generated by the camera module 610 using the modulator-demodulator section 660, and directs transmission of the modulated data to another communication device through the antenna 650.

The host 640 transmits and receives image data, captures an image using the camera module 610, and displays an image on the display panel based on operation information from an operation input section 670.

In FIG. 16, the display panel 620 is described taking the LCD panel as an example. Note that the display panel 620 is not limited to the LCD panel. The display panel 620 may be an electroluminescent display device or a plasma display device. The invention may be applied to a display controller which supplies image data to a display driver which drives such a display device. The display controller 500 may output image data in the YUV format to a CRT device connected with the display controller 500 through an output terminal (not shown).

The invention is not limited to the above-described embodiments. Various modifications and variations may be made within the spirit and scope of the invention. For example, the memory controller according to the above-described embodiment is not limited to a memory controller which controls access to a display memory. The memory controller according to the above-described embodiment may also be applied to a memory controller which controls access to a memory which stores data differing from image data.

The invention according to the dependent claim may have a configuration in which some of the constituent elements of the claim on which the invention is dependent are omitted. It is possible to allow the feature of the invention according to one independent claim to depend on another independent claim.

Although only some embodiments of the invention are described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A memory controller for allowing first to Nth (N is an integer of two or more) functional modules to access a memory, the memory controller comprising:
first to Mth (1<M≦N, M is an integer) data transfer control sections each of which issues a data transfer request for the memory corresponding to an access request supplied to the data transfer control section;
a crossbar switch section which supplies an access request from one of the first to Nth functional modules to one of the first to Mth data transfer control sections;
an arbiter which arbitrates between the data transfer requests from the first to Mth data transfer control sections; and
a memory interface which accesses the memory based on the data transfer request from one of the first to Mth data transfer control sections permitted as a result of arbitration by the arbiter;
each of the data transfer control sections generating an access address of the memory based on the access request supplied to the data transfer control section, and controlling reading of data from the memory or writing of data into the memory using the access address when the data transfer request for the memory has been permitted as a result of arbitration by the arbiter.

2. The memory controller as defined in claim 1,
wherein, when accessing data using a plurality of areas set in a storage area of the memory, each of the data transfer control sections includes a write address generation section which generates a write address for writing data into the memory as the access address, and a read address generation section which generates a read address for reading data from the memory as the access address;
wherein the read address generation section generates the read address for reading data from an area of the memory differing from an area designated by write area information of the memory; and
wherein the write area information is information which designates an area of the memory into which the data is written based on the write address.

3. The memory controller as defined in claim 1,
wherein the memory functions as a display memory which stores image data;
wherein each of the data transfer control sections includes:
a read address generation section which generates a read address for reading the image data from the memory as the access address;
a read data queue in which the image data read from the memory is queued; and
a read synchronization management section which counts a number of pixels of the image data read from the memory and generates a synchronization signal specifying a horizontal display period and a vertical display period of an image expressed by the image data; and
wherein the read address generation section generates the read address which is updated based on the synchronization signal generated by the read synchronization management section.

4. The memory controller as defined in claim 1,
wherein the memory functions as a display memory which stores image data;
wherein each of the data transfer control sections includes:
a write address generation section which generates a write address for writing the image data into the memory as the access address;
a write data queue in which the image data written into the memory is queued; and
a write synchronization queue in which a synchronization signal specifying a horizontal display period and a vertical display period of an image expressed by the image data written into the memory is queued; and
wherein the write address generation section generates the write address which is loaded at a start timing of the vertical display period and updated corresponding to a queuing state of the write data queue based on the synchronization signal output from the write synchronization queue, and generates the write address which is updated to an address for writing image data in the next horizontal display period at an end timing of the horizontal display period based on the synchronization signal output from the write synchronization queue.

5. The memory controller as defined in claim 4,
wherein, when accessing data using a plurality of areas set in a storage area of the memory, each of the data transfer control sections includes:
a read address generation section which generates a read address for reading the image data from the memory as the access address;
a read data queue in which the image data read from the memory is queued; and
a read synchronization management section which counts a number of pixels of the image data read from the memory and generates a synchronization signal specifying a horizontal display period and a vertical display period of an image expressed by the image data;
wherein the read address generation section generates the read address for reading the image data from an area of the memory differing from an area designated by write area information of the memory, the read address being updated based on the synchronization signals generated by the read synchronization management section; and
wherein the write area information is information which designates an area of the memory into which the data is written based on the write address.

6. The memory controller as defined in claim 4,
wherein one of one-bit start information, and one-bit end information respectively indicating a start timing and an end timing of at least one of the horizontal display period and the vertical display period of the image is queued in the write synchronization queue as the synchronization signal.

7. The memory controller as defined in claim 4,
wherein the image data in an amount corresponding to a given number of blocks is queued in the write data queue, each of the blocks containing data in an amount corresponding to a width of a data bus of the memory; and
wherein the synchronization signal is queued in the write synchronization queue in block units.

8. The memory controller as defined in claim 5,
wherein the image data in an amount corresponding to a given number of blocks is queued in the write data queue, each of the blocks containing data in an amount corresponding to a width of a data bus of the memory; and
wherein the synchronization signal is queued in the write synchronization queue in block units.

9. An image processing controller comprising:
first to Nth functional modules each of which issues an access request for a memory;
the memory controller as defined in claim 1; and
a memory to which access is controlled by the memory controller.

10. An image processing controller comprising:
first to Nth functional modules each of which issues an access request for a memory;
the memory controller as defined in claim 2; and
a memory to which access is controlled by the memory controller.

11. An image processing controller comprising:
first to Nth functional modules each of which issues an access request for a memory;
the memory controller as defined in claim 3; and
a memory to which access is controlled by the memory controller.

12. An image processing controller comprising:
an image data input interface for inputting image data;
the memory controller as defined in claim 3;
a display memory to which access is controlled by the memory controller;
a rotation processing section which rotates image data stored in the display memory, the rotation processing section reading the image data from the display memory by issuing a read request to the memory controller, and writing image data obtained by rotating the image data into the display memory by issuing a write request to the memory controller; and
an image data output interface for outputting the image data read from the display memory.

13. An image processing controller comprising:
an image data input interface for inputting image data;
the memory controller as defined in claim 4;
a display memory to which access is controlled by the memory controller;
a rotation processing section which rotates image data stored in the display memory, the rotation processing section reading the image data from the display memory by issuing a read request to the memory controller, and writing image data obtained by rotating the image data into the display memory by issuing a write request to the memory controller; and
an image data output interface for outputting the image data read from the display memory.

14. An image processing controller comprising:
an image data input interface for inputting image data;
the memory controller as defined in claim 5;
a display memory to which access is controlled by the memory controller;
a rotation processing section which rotates image data stored in the display memory, the rotation processing section reading the image data from the display memory by issuing a read request to the memory controller, and writing image data obtained by rotating the image data into the display memory by issuing a write request to the memory controller; and
an image data output interface for outputting the image data read from the display memory.

15. The image processing controller as defined in claim 12,
wherein a storage area of the display memory includes a triple buffer area and a double buffer area;
wherein the triple buffer area is accessed by the image data input interface and the rotation processing section; and
wherein the double buffer area is accessed by the rotation processing section and the image data output interface.

16. The image processing controller as defined in claim 13,
wherein a storage area of the display memory includes a triple buffer area and a double buffer area;
wherein the triple buffer area is accessed by the image data input interface and the rotation processing section; and
wherein the double buffer area is accessed by the rotation processing section and the image data output interface.

17. The image processing controller as defined in claim 14,
wherein a storage area of the display memory includes a triple buffer area and a double buffer area;
wherein the triple buffer area is accessed by the image data input interface and the rotation processing section; and
wherein the double buffer area is accessed by the rotation processing section and the image data output interface.

18. An electronic instrument comprising:
a display device;
the image processing controller as defined in claim 9; and
a display driver which drives the display device based on image data supplied from the image processing controller.

19. An electronic instrument comprising:
a display device;
the image processing controller as defined in claim 10; and
a display driver which drives the display device based on image data supplied from the image processing controller.

20. An electronic instrument comprising:
a display device;
the image processing controller as defined in claim 11; and
a display driver which drives the display device based on image data supplied from the image processing controller.
